(19) United States
(12) Patent Application Publication
(10) Pub. No.: US 2024/0170775 A1
(43) Pub. Date: May 23, 2024

(54) BUTTON CELL

(71) Applicant: SAMSUNG SDI CO., LTD., Yongin-si (KR)

(72) Inventor: Byongchul WOO, Yongin-si (KR)

(21) Appl. No.: 18/222,365

(22) Filed: Jul. 14, 2023

(30) Foreign Application Priority Data
Nov. 23, 2022 (KR) 10-2022-0158689

(51) Int. Cl. H01M 50/186; H01M 50/109; H01M 50/153; H01M 50/166; H01M 50/536; H01M 50/559

(52) U.S. Cl. CPC H01M 50/186; H01M 50/109; H01M 50/153; H01M 50/166; H01M 50/536; H01M 50/559

(57) ABSTRACT

A button cell includes: an electrode assembly including a first electrode, a second electrode, and a separator between the first electrode and the second electrode; a first plate below the electrode assembly and connected to the first electrode; a second plate above the electrode assembly and connected to the second electrode; and an insulating pouch at a side portion of the electrode assembly. The insulating pouch seals the electrode assembly with the first plate and the second plate and has a first fused portion overlapping in a vertical direction and thermally fused to an edge of a lower surface of the first plate and a second fused portion overlapping in the vertical direction and thermally fused to an edge of an upper surface of the second plate.

### CROSS-REFERENCE TO RELATED APPLICATION

This application claims priority to and the benefit of Korean Patent Application No. 10-2022-0158689, filed in the Korean Intellectual Property Office on Nov. 23, 2022, the entire content of which is incorporated herein by reference.

### BACKGROUND

### 1. Field

Aspects of embodiments of the present disclosure relate to a button cell.

### 2. Description of the Related Art

Generally, a rechargeable (or secondary) battery is a battery that is designed to be (re)charged and discharged.

Recently, as a demand for wearable devices, such as headphones, earphones, smartwatches, and body-attached medical devices that utilize wireless communication, such as the Bluetooth protocol, increases, demand for a button cell, which is a micro-sized rechargeable battery that can be mounted in a wearable device, is increasing.

A conventional button cell includes an electrode assembly including positive and negative electrodes and a separator positioned between the positive and negative electrodes, a case accommodating the electrode assembly, a cap plate welded to the case, and a terminal plate insulated from and bonded to the cap plate.

However, in the conventional button cell, when the case, which accommodates the electrode assembly, and the cap plate are welded together during a manufacturing process of the button cell, the separator of the electrode assembly may be melted by the welding heat, causing a short circuit between opposite electrodes in the electrode assembly.

The above information disclosed in this Background section is for enhancement of understanding of the background of the present disclosure, and therefore, it may contain information that does not form prior art already known to a person of ordinary skill in the art.

### SUMMARY

Embodiment of the present disclosure provide a button cell having improved battery capacity and that prevents an electrode assembly from being damaged by welding heat.

A button cell, according to an embodiment of the present disclosure, includes: an electrode assembly including a first electrode, a second electrode, and a separator between the first electrode and the second electrode; a first plate below the electrode assembly and connected to the first electrode; a second plate above the electrode assembly and connected to the second electrode; and an insulating pouch at a side portion of the electrode assembly. The insulating pouch seals the electrode assembly with the first plate and the second plate and has a first fused portion overlapping in a vertical direction and thermally fused to an edge of a lower surface of the first plate and a second fused portion overlapping in the vertical direction and thermally fused to an edge of an upper surface of the second plate.

The first fused portion may overlap the entire edge of the lower surface of the first plate in the vertical direction, and the second fused portion may overlap the entire edge of the upper surface of the second plate in the vertical direction.

The insulating pouch may have a body portion extending in the vertical direction to surround the side portion of the electrode assembly, the first fused portion bent and extending from the body portion toward a center of the lower surface of the first plate, and the second fused portion extending from the body portion toward a center of the upper surface of the second plate.

The electrode assembly may further include a first electrode tab extending from the first electrode and welded to the first plate, and a second electrode tab extending from the second electrode and welded to the second plate.

The electrode assembly may be wound about a vertical axis in a jelly roll shape, and the lower surface of the first plate and the upper surface of the second plate may each have a circular shape in a plane view.

The insulating pouch may have a ring shape in the plane view.

The first plate may have a thickness that is smaller than that of the insulating pouch.

The second plate may have a thickness that is smaller than that of the insulating pouch.

The first plate may have a thickness that is smaller than that of the second plate.

The first plate may include a material having greater strength than that of the second plate.

The first plate may include stainless steel, and the second plate may include aluminum.

The first fused portion of the insulating pouch may form a first opening exposing a lower portion of the electrode assembly, the first plate may cover the first opening, the second fused portion of the insulating pouch may form a second opening exposing an upper portion of the electrode assembly, and the second plate may cover the second opening.

The second plate may include a cap plate thermally fused to the second fused portion and covering an outer area of the second opening. The second plate may have a through hole exposing a central area of the second opening and a terminal plate connected to the second electrode, insulatively bonded to the cap plate, and covering the through hole.

The button cell may further include a bonding layer between the cap plate and the terminal plate and insulatively bonding the cap plate and the terminal plate.

The terminal plate may have a flange portion covering the through hole and contacting the bonding layer, and a protrusion extending from the flange portion through the through hole.

The electrode assembly may further include a first electrode tab extending from the first electrode and welded to the first plate, and a second electrode tab extending from the second electrode and welded to the protrusion of the terminal plate.

The first plate may have a thickness that is smaller than that of the second plate.

The first plate may have a thickness that is smaller than that of the insulating pouch.

The button cell may include (or may be) a coin cell.

A ratio (e.g., height/diameter) of a height to a diameter of the button cell may be 1 or less.

According to embodiments of the present disclosure, a button cell having improved battery capacity and that prevents an electrode assembly from being damaged by welding heat is provided.

### BRIEF DESCRIPTION OF THE DRAWINGS

FIG. 1 illustrates a perspective view of a button cell according to an embodiment.

FIG. 2 illustrates a cross-sectional view of the button cell taken along the line II-II in FIG. 1.

FIG. 3 illustrates a perspective view of a button cell according to another embodiment.

FIG. 4 illustrates a cross-sectional view of the button cell taken along the line IV-IV in FIG. 3.

### DETAILED DESCRIPTION

The present disclosure will be described more fully hereinafter with reference to the accompanying drawings, in which embodiments of the present disclosure are shown. As those skilled in the art would realize, the described embodiments may be modified in various different ways, all without departing from the spirit or scope of the present disclosure.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

A button cell is a micro-sized secondary battery and may include (or may be referred to as) a coin cell. A button cell, as referred to herein, is not limited thereto and may include a cylindrical or pin-type battery.

A button cell, which is a battery in the form of a thin coin or button, may refer to (or indicate) a battery having a height-to-diameter ratio (height/diameter) of 1 or less, but the present disclosure is not limited thereto. The button cell is primarily (or generally) cylindrical with a circular horizontal cross-section, but the present disclosure is not limited thereto. In some embodiments, the horizontal cross-section may have an oval or polygonal shape. In embodiments having a non-circular horizontal cross-section, a diameter may indicate a maximum distance (e.g., a greatest or maximum diameter) based on a horizontal direction of the battery, and a height may indicate a maximum distance (e.g., a distance from a flat bottom surface to a flat top surface) based on a vertical direction of the battery.

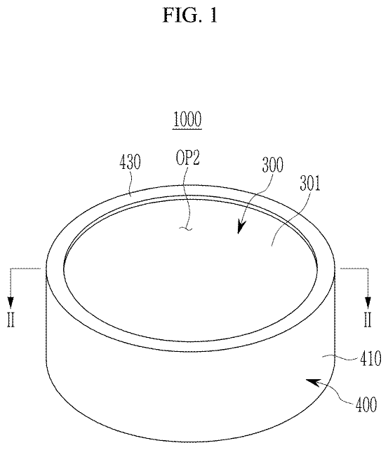

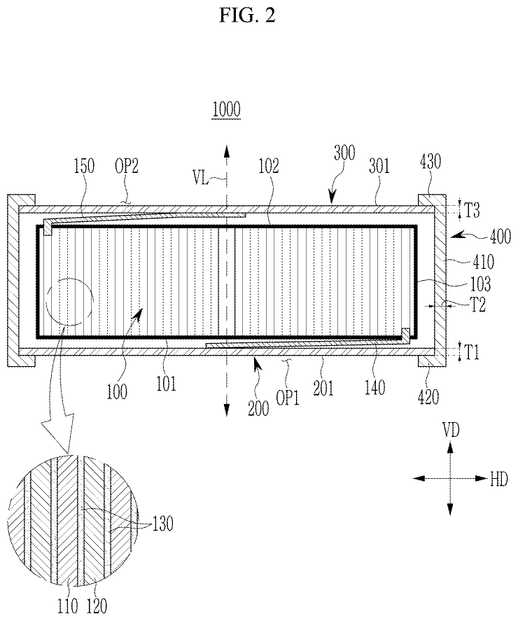

FIG. 1 illustrates a perspective view of a button cell according to an embodiment, and FIG. 2 illustrates a cross-sectional view of the button cell taken along the line II-II in FIG. 1.

Referring to FIG. 1 to FIG. 2, a button cell 1000 is a rechargeable battery designed to be charged and discharged and, according to an embodiment, includes an electrode assembly 100, a first plate 200, a second plate 300, and an insulating pouch 400.

The electrode assembly 100 is sealed (e.g., sealed from the outside environment) by the first plate 200, the second plate 300, and the insulating pouch 400. A lower portion (or a lower surface) 101 of the electrode assembly 100 faces the first plate 200, an upper portion (or an upper surface) 102 of the electrode assembly 100 faces the second plate 300, and a side portion (or a lateral or side surface) 103 of the electrode assembly 100 faces the insulating pouch 400. The upper portion 102 and the lower portion 101 of the electrode assembly 100 may have parallel planar shapes, and the side portion 103 of the electrode assembly 100 may have a cylindrical shape, but the present disclosure is not limited thereto.

The electrode assembly 100 includes a first electrode 110, a second electrode 120, a separator 130, a first electrode tab 140, and a second electrode tab 150.

The first electrode 110 and the second electrode 120 are spaced apart from each other by a separator 130 including an insulating material positioned therebetween. The first electrode 110 may be an anode, and the second electrode 120 may be a cathode, but the present disclosure is not limited thereto. In other embodiments, the first electrode 110 may be the cathode, and the second electrode 120 may be the anode.

The first electrode 110 has a band shape extending in a direction and includes an anode coated region, which is an area where an anode active material layer is applied to a current collector of a metal foil (e.g., a Cu foil, etc.) and an anode uncoated region, which is a region where no active material is applied. The anode uncoated region may be positioned at an end of the first electrode 110 in an extension direction.

The second electrode 120 has a band shape extending in a direction and is spaced apart from the first electrode 110 with the separator 130 provided therebetween. The second electrode 120 includes a cathode coated region, which is a region where a cathode active material layer is applied to a current collector of a metal foil (e.g., an Al foil, etc.) and a cathode uncoated region, which is a region where no active material is applied. The cathode uncoated region may be positioned at an end of the second electrode 120 in an extension direction.

The separator 130 extends in a direction between the first electrode 110 and the second electrode 120 to prevent a short circuit between the first electrode 110 and the second electrode 120.

The first electrode 110, the separator 130, and the second electrode 120 are sequentially stacked and then wound to have a jelly roll shape about one vertical line VL (e.g., wound about a winding axes) at a center thereof, but the present disclosure is not limited thereto, and they may be formed or arranged in various known shapes or arrangements. Herein, the one vertical line VL includes, but is not limited to, a virtual vertical line (or axis) passing through a center of the second plate 300 in a vertical direction.

The first electrode tab 140 extends from the first electrode 110 of the electrode assembly 100 to the first plate 200. The first electrode tab 140 is coupled to the first plate 200 to connect the first electrode 110 and the first plate 200. The first electrode tab 140 is in contact with the first electrode 110 and the first plate 200. The first electrode tab 140 may be welded to a surface of the first plate 200, but the present disclosure is not limited thereto. In some embodiments, the first electrode tab 140 may be in contact with the surface of the first plate 200. The first plate 200 has a same polarity as that of the first electrode 110 due to the first electrode tab 140. The second electrode tab 150 extends from the second electrode 120 of the electrode assembly 100 to the second plate 300. The second electrode tab 150 is coupled to the second plate 300 to connect the second electrode 120 and the second plate 300. The second electrode tab 150 is in contact with the second electrode 120 and the second plate 300. The second electrode tab 150 may be welded to a surface of the second plate 300, but the present disclosure is not limited thereto. In some embodiments, the second electrode tab 150 may come into contact with the surface of the second plate 300. The second plate 300 has a same polarity as that of the second electrode 120 due to the second electrode tab 150.

The button cell 1000 may include a center pin penetrating (e.g., extending through) a center of the electrode assembly 100 in a vertical direction at a central portion (or central position) of the electrode assembly 100. The center pin may support the first electrode tab 140 and the second electrode tab 150, but the present disclosure is not limited thereto.

The first plate 200 is positioned on (or under) the lower portion 101 of the electrode assembly 100. The first plate 200 is connected insulating pouch 400 to seal the electrode assembly 100 together with the second plate 300. Because the first plate 200 is welded to the first electrode tab 140 to be connected to the first electrode 110 of the electrode assembly 100, the first plate 200 has a same polarity as that of the first electrode 110. The lower (or outer) surface 201 of the first plate 200 has a circular shape in a plane view corresponding to the lower portion 101 of the electrode assembly 100 in the form of a jelly roll, but the present disclosure is not limited thereto. In other embodiments, the lower surface 201 of the first plate 200 may have various shapes. The first plate 200 may accommodate the electrode assembly 100 and various known electrolyte solutions in an internal space sealed by the insulating pouch 400 and the second plate 300 together. The lower surface 201, in a vertical direction VD, which is an outer surface of the first plate 200, may be the first electrode terminal of the button cell 1000, but the present disclosure is not limited thereto. In such an embodiment, an upper surface 301 of the second plate 300 in the vertical direction VD, which is an outer surface of the second plate 300, may be the second electrode terminal of the button cell 1000, but the present disclosure is not limited thereto. In some embodiments, a plating layer may be coated on the first plate 200 (e.g., on the surface of the first plate 200), the present disclosure is not limited thereto. In such an embodiment, various known coating layers may be coated on the first plate 200. The first plate 200 may include stainless steel, but the present disclosure is not limited thereto. The first plate 200 may include various known metals. An edge of the lower surface 201 of the first plate 200 in the vertical direction VD overlaps a first fused portion 420 of the insulating pouch 400 in the vertical direction VD, which is the extending direction of the one vertical line VL. The first fused portion 420 of the insulating pouch 400 is thermally fused to (or along) an entire edge of the lower surface 201 of the first plate 200. A first thickness T1 of the first plate 200 is smaller than a second thickness T2 of the insulation pouch 400 and a third thickness T3 of the second plate 300. For example, the first plate 200 may have the first thickness T1 in a range of about 0.01 mm to about 0.1 mm, but the present disclosure is not limited thereto.

The second plate 300 is positioned on (or over) the upper portion 102 of the electrode assembly 100. The second plate 300 is connected to insulating pouch 400 to seal the electrode assembly 100 together with the first plate 200. Because the second plate 300 is welded to the second electrode tab 150 to be connected to the second electrode 120 of the electrode assembly 100, the second plate 300 has a same polarity as that of the second electrode 120. The upper surface 301 of the second plate 300 has a circular shape in a plane view corresponding to the upper portion 102 of the electrode assembly 100 in the form of a jelly roll, but the present disclosure is not limited thereto, and the upper surface 301 may have various shapes. The second plate 300 may accommodate the electrode assembly 100 and various known electrolyte solutions in an internal space sealed by the insulating pouch 400 and the first plate 200 together. The upper surface 301 of the second plate 300, which is the outer surface of the second plate 300, may be the second electrode terminal of the button cell 1000, but the present disclosure is not limited thereto. In some embodiments, a plating layer may be coated on the second plate 300 (e.g., on the surface of the second plate 300), but the present disclosure is not limited thereto. Various known coating layers may be coated on the second plate 300. The second plate 300 may include aluminum, but the present disclosure is not limited thereto, and the second plate 300 may include various known metals. An edge of the upper surface 301 of the second plate 300 overlaps a second fused portion 430 of the insulating pouch 400 in the vertical direction VD, which is the extending direction of one vertical line VL, and the second fused portion 430 of the insulating pouch 400 is thermally fused to (or along) an entire edge of the upper surface 301 of the second plate 300. The third thickness T3 of the second plate 300 is smaller than the second thickness T2 of the insulating pouch 400. For example, the second plate 300 may have the second thickness T2 in a range of about 0.01 mm to about 0.1 mm, but the present disclosure is not limited thereto.

The insulating pouch 400 is positioned on (or covering) the side portion 103 of the electrode assembly 100. The insulating pouch 400 insulates between the first plate 200 connected to the first electrode 110 and the second plate 300 connected to the second electrode 120 and seals the electrode assembly 100 together with the first plate 200 and second plate 300. The insulation pouch 400 has a ring shape in a plane view corresponding to the side portion 103 of the electrode assembly 100, but the present disclosure is not limited thereto. The insulating pouch 400 includes a resin, which is one of known various insulating materials, such as polypropylene and polyimide.

The insulating pouch 400 has a body portion 410, the first fused portion 420, and the second fused portion 430.

The body portion 410 extends in the vertical direction VD corresponding to the side portion 103 of the electrode assembly 100 in the form of a jelly roll to surround (e.g., to surround in the plane view) the side portion 103 of the electrode assembly 100 in a horizontal direction HD crossing the vertical direction VD. The body portion 410 has a ring shape in a plane view corresponding to the side portion 103 of the electrode assembly 100, but the present disclosure is not limited thereto, and the body portion 410 may have various polygonal, elliptical, circular, or loop shapes.

The first fused portion 420 is bent and extends from a lower portion (or lower edge) of the body portion 410 in the vertical direction VD toward a center of the lower surface 201 of the first plate 200. The first fused portion 420 overlaps an edge of the lower surface 201 of the first plate 200 in the vertical direction VD to be thermally fused therewith. The first fused portion 420 overlaps an entire edge of the lower surface 201 of the first plate 200 in the vertical direction VD to be thermally fused with the entire edge of the lower surface 201 of the first plate 200. The first fused portion 420 forms a first opening OP1 exposing the lower portion 101 of the electrode assembly 100, and the first opening OP1 is covered by (e.g., is covered at one end by) the first plate 200, to which the first fused portion 420 is thermally fused.

The second fused portion 430 is bent and extends from an upper portion (or upper edge) of the body portion 410 in the vertical direction VD toward a center of the upper surface 301 of the second plate 300. The second fused portion 430 overlaps an edge of the upper surface 301 of the second plate 300 in the vertical direction VD to be thermally fused therewith. The second fused portion 430 overlaps an entire edge of the upper surface 301 of the second plate 300 in the vertical direction VD to be thermally fused with the entire edge of the upper surface 301 of the second plate 300. The second fused portion 430 forms a second opening OP2 exposing the upper portion 102 of the electrode assembly 100, and the second opening OP2 is covered by (e.g., is covered at one end by) the second plate 300 to which the second fused portion 430 is thermally fused.

The second thickness T2 of the insulating pouch 400 is thicker than the first thickness T1 of the first plate 200 and the third thickness T3 of the second plate 300. For example, the insulating pouch 400 may have the second thickness T2 in a range of about 0.01 mm to about 0.1 mm, but the present disclosure is not limited thereto.

For example, a manufacturing process of the button cell 1000 may include forming a shape of the insulating pouch 400, thermally fusing the first fused portion 420 of the insulating pouch 400 to an edge of the lower surface 201 of the first plate 200, accommodating the electrode assembly 100 in an inner space formed by the first plate 200 and the insulating pouch 400, and sealing the electrode assembly 100 with the first plate 200, the second plate 300, and the insulating pouch 400 by thermally fusing the second fused portion 430 of the insulating pouch 400 to an edge of the upper surface 301 of the second plate 300. For example, because the first fused portion 420 of the insulating pouch 400 is thermally fused to the lower surface 201 of the first plate 200, and the second fused portion 430 is thermally fused to the upper surface 301 of the second plate 300, the electrode assembly 100 is sealed by the first plate 200, the second plate 300, and the insulating pouch 400 without a welding process, the electrode assembly 100 is not damaged by welding heat.

The first plate 200 is thinner than the insulating pouch 400 and the second plate 300, and the second plate 300 is thinner than the insulating pouch 400. For example, the first thickness T1 of the first plate 200 is smaller than the second thickness T2 of the insulation pouch 400 and the third thickness T3 of the second plate 300, and the third thickness T3 of the second plate 300 is smaller than the second thickness T2 of the insulation pouch 400.

The first plate 200 includes a material having greater strength than the second plate 300 and the insulating pouch 400, the second plate 300 includes a material having greater strength than the insulating pouch 400. In one embodiment, the first plate 200 includes stainless steel, the second plate 300 includes aluminum, and the insulating pouch 400 includes a resin, such as polypropylene or a polyimide. Accordingly, because the first thickness T1 of the first plate 200 may be smaller (or thinner) than the second thickness T2 of the insulating pouch 400 and the third thickness T3 of the second plate 300, and the third thickness T3 of the second plate 300 may be smaller (or thinner) than the second thickness T2 of the insulating pouch 400, the size of the electrode assembly 100 may be increased or maximized by maximizing the internal space sealed by the first plate 200, the second plate 300, and the insulating pouch 400 relative to the outer dimensions of the button cell 1000, thereby improving battery capacity of the button cell 1000.

As such, in the button cell 1000 according to an embodiment, the first fused portion 420 of the insulating pouch 400 is thermally fused to the lower surface 201 of the first plate 200, and the second fused portion 430 is thermally fused to the upper surface 301 of the second plate 300, and therefore, the electrode assembly 100 is sealed by the first plate 200, the second plate 300, and the insulating pouch 400 without a welding process, preventing the electrode assembly 100 from being damaged by welding heat.

In addition, in the button cell 1000 according to an embodiment, the first thickness T1 of the first plate 200 may be smaller than the second thickness T2 of the insulating pouch 400 and the third thickness T3 of the second plate 300, and the third thickness T3 of the second plate 300 may be smaller than the second thickness T2 of the insulating pouch 400, the size (e.g., the relative size) of the electrode assembly 100 may be maximized by maximizing the internal space sealed by the first plate 200, the second plate 300, and the insulating pouch 400, thereby improving battery capacity of the button cell 1000.

Thus, according to an embodiment of the present disclosure, the button cell 1000 has improved battery capacity and prevents the electrode assembly 100 from being damaged by welding heat.

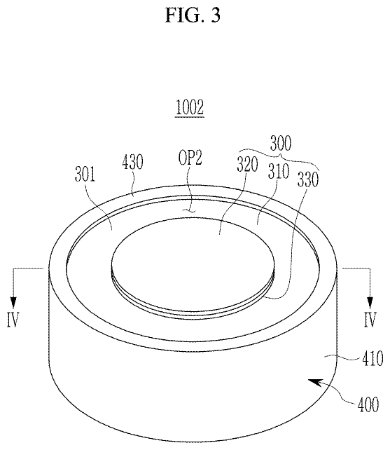

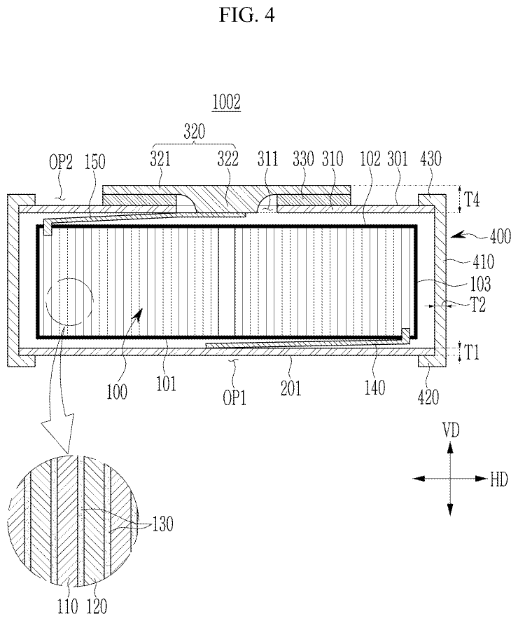

Hereinafter, a button cell according to another embodiment will be described with reference to FIG. 3 and FIG. 4. Hereinafter, the button cell according to another embodiment shown in FIG. 3 and FIG. 4 will be described by primarily focusing on differences with respect to from button cell according to the above-described embodiment shown in FIG. 1 and FIG. 2.

FIG. 3 illustrates a perspective view of a button cell according to another embodiment, and FIG. 4 illustrates a cross-sectional view of the button cell shown in FIG. 3 taken along the line IV-IV in FIG. 3.

Referring to FIG. 3 and FIG. 4, a button cell 1002, according to another embodiment, includes an electrode assembly 100, a first plate 200, a second plate 300, and an insulating pouch 400.

The second plate 300 includes a cap plate 310, a terminal plate 320, and a bonding layer 330.

The cap plate 310 is thermally fused to the second fused portion 430 of the insulating pouch 400 to cover an outer area of the second opening OP2 formed by the second fused portion 430. The cap plate 310 has a through hole 311 exposing a central area of the second opening OP2. The cap plate 310 has a ring shape around the through hole 311 formed in the center thereof, but the present disclosure is not limited thereto. The cap plate 310 is not electrically connected to the second electrode 120 and has no polarity. The cap plate 310 includes stainless steel, but the present disclosure is not limited thereto, and the cap plate 310 may include various known metals. An edge of the upper surface 301 of the cap plate 310, which is an edge of the upper surface 301 of the second plate 300, is thermally fused to the second fused portion 430. The edge of the upper surface 301 of the cap plate 310 overlaps the second fused portion 430 of the insulating pouch 400 in the vertical direction VD.

The terminal plate 320 is connected to the second electrode 120 and is insulated from and bonded to the cap plate 310 by the bonding layer 330. The terminal plate 320 covers the through hole 311 of the cap plate 310. The terminal plate 320 is positioned on the cap plate 310. The terminal plate 320 covers a central area of the second opening OP2 exposed by the through hole 311 of the cap plate 310. Because the terminal plate 320 covers the central area of the second opening OP2 and the cap plate 310 covers the outer area of the second opening OP2, the second opening OP2 formed by the second fused portion 430 of the insulating pouch 400 is completely covered by the second plate 300 including the terminal plate 320 and the cap plate 310. The terminal plate 320 is coupled to the second electrode tab 150 of the electrode assembly 100 to be connected to the second electrode 120 of the electrode assembly 100. Thus, the terminal plate 320 has same polarity as that of the second electrode 120.

The terminal plate 320 includes a flange portion 321 and a protrusion 322.

The flange portion 321 is positioned on the cap plate 310 and overlaps the cap plate 310 to cover the through hole 311. The flange portion 321 has a larger area than that of the protrusion 322. For example, the flange portion 321 may have a larger diameter than that of the protrusion 322. The flange portion 321 has a smaller thickness than that of the protrusion 322, but the present disclosure is not limited thereto. A lower surface of the flange portion 321 contacts the bonding layer 330, and the flange portion 321 is insulatively bonded to the cap plate 310 by the bonding layer 330. An upper surface of the flange portion 321 may be a second electrode terminal of the button cell 1000.

The protrusion 322 protrudes from the flange portion 321 and extends into (or through) the through hole 311. The protrusion 322 is connected to the second electrode 120 through the through hole 311. A surface of the protrusion 322 is coupled to the second electrode tab 150. The surface of the protrusion 322 may be welded to the second electrode tab 150, but the present disclosure is not limited thereto. Because the protrusion 322 is coupled to the second electrode tab 150, the protrusion 322 and the flange portion 321 of the terminal plate 320 have the same polarity as that of the second electrode 120. The surface of the protrusion 322 coupled with the second electrode tab 150 may have a smaller diameter than that of an upper surface of the flange portion 321, which may be an electrode terminal. The protrusion 322 and the flange portion 321 are integrally formed by using a forging process, but the present disclosure is not limited thereto. In other embodiments, the protrusion 322 and the flange portion 321 may be formed of different materials and combined to form the terminal plate 320.

A plating layer may be coated on the outer surface of the terminal plate 320, but the present disclosure is not limited thereto. Various known coating layers may be coated on the outer surface of the terminal plate 320. The terminal plate 320 includes aluminum, but the present disclosure is not limited thereto, and the terminal plate 320 may include various known metals.

The bonding layer 330 is positioned between the cap plate 310 and the flange portion 321 of the terminal plate 320. The bonding layer 330 insulates and bonds between the cap plate 310 and the terminal plate 320. The bonding layer 330 includes an insulating material and insulates between the cap plate 310 and the terminal plate 320. The bonding layer 330 is thermally fused between the cap plate 310 and the flange portion 321 of the terminal plate 320 by using heat or a laser beam. The bonding layer 330 includes a resin, such as polypropylene or a polyimide, but the present disclosure is not limited thereto, and the bonding layer 330 may include various known resins for insulating bonding between the cap plate 310 and the terminal plate 320.

For example, the bonding layer 330 may include a thermosetting resin and a thermoplastic resin. The thermosetting resin and the thermoplastic resin of the bonding layer 330 may be stacked in a plurality of layers, but the prevent disclosure is not limited thereto. The thermosetting resin of the bonding layer 330 is cured by heat and may include various known thermosetting resins, such as a phenol resin, a urea resin, a melamine resin, an epoxy resin, and a polyester resin. The thermoplastic resin of the bonding layer 330 includes, but is not limited to, a polypropylene resin that melts at a reference temperature, and may include various known thermoplastic resins, such as polystyrene, polyethylene, and a polyvinyl chloride resin.

A first thickness T1 of the first plate 200 has is smaller than a second thickness T2 of the insulation pouch 400 and a fourth thickness T4 of the second plate 300. For example, the first plate 200 may have the first thickness T1 in a range of about 0.01 mm to about 0.1 mm, but the present disclosure is not limited thereto.

The fourth thickness T4 of the second plate 300 is greater than the second thickness T2 of the insulating pouch 400 and the first thickness T1 of the first plate 200. For example, the second plate 300 may have the fourth thickness T4 in a range of about 0.1 mm to about 1 mm, but the present disclosure is not limited thereto.

As such, in the button cell 1002, the first fused portion 420 of the insulating pouch 400 is thermally fused to the lower surface 201 of the first plate 200, and the second fused portion 430 is thermally fused to the upper surface 301 of the cap plate 310, which is the upper surface 301 of the second plate 300. Accordingly, the electrode assembly 100 is sealed by the first plate 200, the second plate 300, and the insulating pouch 400 without a welding process, and the electrode assembly 100 is prevented from being damaged by welding heat.

In addition, in the button cell 1002, the first thickness T1 of the first plate 200 is smaller than the second thickness T2 of the insulating pouch 400 and the fourth thickness T4 of the second plate 300 such that the size of the electrode assembly 100 may be maximized by maximizing an internal space sealed by the first plate 200, the second plate 300, and the insulating pouch 400, thereby improving the battery capacity of the button cell 1002.

The button cell 1002 has improved battery capacity and prevents damage to the electrode assembly 100 by welding heat.

While the present disclosure has been described in connection with what is presently considered to be practical embodiments, it is to be understood that the present disclosure is not limited to the disclosed embodiments, but, on the contrary, is intended to cover various modifications and equivalent arrangements included within the spirit and scope of the appended claims and their equivalents.

Description of Some Reference Symbols

| | | | |
|---|---|---|---|
| 100 | electrode assembly | 200 | first plate |
| 300 | second plate 300 | 400 | insulating pouch |

What is claimed is:

1. A button cell comprising:
an electrode assembly comprising a first electrode, a second electrode, and a separator between the first electrode and the second electrode;
a first plate below the electrode assembly and connected to the first electrode;
a second plate above the electrode assembly and connected to the second electrode; and
an insulating pouch at a side portion of the electrode assembly, the insulating pouch sealing the electrode assembly with the first plate and the second plate, the insulating pouch has a first fused portion overlapping in a vertical direction and thermally fused to an edge of a lower surface of the first plate and a second fused portion overlapping in the vertical direction and thermally fused to an edge of an upper surface of the second plate.

2. The button cell of claim 1, wherein the first fused portion overlaps the entire edge of the lower surface of the first plate in the vertical direction, and
wherein the second fused portion overlaps the entire edge of the upper surface of the second plate in the vertical direction.

3. The button cell of claim 1, wherein the insulating pouch has:
a body portion extending in the vertical direction to surround the side portion of the electrode assembly;
the first fused portion bent and extending from the body portion toward a center of the lower surface of the first plate; and
the second fused portion bent and extending from the body portion toward a center of the upper surface of the second plate.

4. The button cell of claim 1, wherein the electrode assembly comprises:
a first electrode tab extending from the first electrode and welded to the first plate; and
a second electrode tab extending from the second electrode and welded to the second plate.

5. The button cell of claim 1, wherein the electrode assembly is wound about a vertical axis in a jelly roll shape, and
wherein the lower surface of the first plate and the upper surface of the second plate each have a circular shape in a plane view.

6. The button cell of claim 5, wherein the insulating pouch has a ring shape in the plane view.

7. The button cell of claim 1, wherein the first plate has a thickness that is smaller than that of the insulating pouch.

8. The button cell of claim 7, wherein the second plate has a thickness that is smaller than that of the insulating pouch.

9. The button cell of claim 7, wherein the first plate has a thickness that is smaller than that of the second plate.

10. The button cell of claim 9, wherein the first plate comprises a material having greater strength than that of the second plate.

11. The button cell of claim 10, wherein the first plate comprises stainless steel, and
wherein the second plate comprises aluminum.

12. The button cell of claim 1, wherein the first fused portion of the insulating pouch forms a first opening exposing a lower portion of the electrode assembly,
wherein the first plate covers the first opening,
wherein the second fused portion of the insulating pouch forms a second opening exposing an upper portion of the electrode assembly, and
wherein the second plate covers the second opening.

13. The button cell of claim 12, wherein the second plate comprises:
a cap plate thermally fused to the second fused portion and covering an outer area of the second opening, the cap plate having a through hole exposing a central area of the second opening; and
a terminal plate connected to the second electrode, insulatively bonded to the cap plate, and covering the through hole.

14. The button cell of claim 13, further comprising a bonding layer between the cap plate and the terminal plate and insulatively bonding the cap plate and the terminal plate.

15. The button cell of claim 14, wherein the terminal plate has:
a flange portion covering the through hole and contacting the bonding layer; and
a protrusion extending from the flange portion through the through hole.

16. The button cell of claim 15, wherein the electrode assembly comprises:
a first electrode tab extending from the first electrode and welded to the first plate; and
a second electrode tab extending from the second electrode and welded to the protrusion of the terminal plate.

17. The button cell of claim 13, wherein the first plate has a thickness that is smaller than that of the second plate.

18. The button cell of claim 13, wherein the first plate has a thickness that is smaller than that of the insulating pouch.

19. The button cell of claim 1, wherein the button cell comprises a coin cell.

20. The button cell of claim 1, wherein a ratio of a height to a diameter of the button cell is 1 or less.
